(19) United States
(12) Patent Application Publication
(10) Pub. No.: US 2022/0197236 A1
(43) Pub. Date: Jun. 23, 2022

(54) HIERARCHICAL HIGH INTEGRITY AUTOMATION SYSTEM

(71) Applicant: Rockwell Collins, Inc., Cedar Rapids, IA (US)

(72) Inventors: Bryan M. Krawiec, Ashburn, VA (US); Alexander V. Roup, Centreville, VA (US)

(73) Assignee: Rockwell Collins, Inc., Cedar Rapids, IA (US)

(21) Appl. No.: 17/127,727

(22) Filed: Dec. 18, 2020

(51) Int. Cl. G05B 19/042; G05B 19/04; G06F 11/14

(52) U.S. Cl. CPC G05B 19/0425; G06F 11/1448; G05B 19/041

(57) ABSTRACT

A hierarchical high integrity system is disclosed. The system may include one or more operator input interfaces configured to receive one or more operator commands from an operator. The system may further include a hierarchy of a plurality of functional layers configured to perform one or more functions in response to the one or more operator commands. The hierarchy of the plurality of functional layers may include one or more upper functional layers and one or more lower functional layers. The one or more upper functional layers may configured to provide a greater level of automation than the one or more lower functional layers. Each functional layer may include a plurality of applications; an arbitrator configured to dynamically select the appropriate input source; an application selector configured to dynamically select an application; and a default safe fallback module configured to selectively provide a substantially safe operation for each functional layer.

### BACKGROUND

Autonomous systems must be able to adapt quickly to emerging and evolving technological and strategic threats. However, many autonomous systems and other like control-intensive software architectures are highly complex and interconnected, which precludes easy and/or inexpensive modular upgrades.

### SUMMARY

A hierarchical automation system is disclosed, in accordance with one or more embodiments of the disclosure. In one embodiment, the system includes one or more operator input interfaces configured to receive one or more operator commands from an operator. In another embodiment, the system includes a hierarchy of a plurality of functional layers configured to perform one or more functions in response to the received one or more operator commands, the hierarchy of the plurality of functional layers including one or more upper functional layers and one or more lower functional layers, the one or more upper functional layers configured to provide a greater level of automation than the one or more lower functional layers. In another embodiment, each functional layer of the plurality of functional layers includes a plurality of applications. In another embodiment, each functional layer of the plurality of functional layers includes an arbitrator configured to dynamically select an appropriate input source for the plurality of applications. In another embodiment, each functional layer of the plurality of functional layers includes an application selector configured to dynamically select an application of the plurality of applications to perform the one or more functions. In another embodiment, each functional layer of the plurality of functional layers includes a default safe fallback module configured to selectively provide a substantially safe operation for each functional layer of the plurality of functional layers to perform. In another embodiment, each upper functional layer of the one or more upper functional layers is configured to dynamically provide one or more commands to at least one lower functional layer of the one or more lower functional layers, the at least one lower functional layer of the one or more lower functional layers being configured to provide a lower level of automation than each upper functional layer of the one or more upper functional layers. In another embodiment, each lower functional layer of the one or more lower functional layers is configured to provide one or more status outputs to each upper functional layer of the one or more upper functional layers, the at least one upper functional layer of the one or more upper functional layers being configured to provide a greater level of automation than each lower functional layer of the one or more lower functional layers.

In some embodiments, the plurality of applications may include one or more high integrity applications configured to provide high integrity behavior, the high integrity behavior being configured to provide a substantially safe operation within a set of operating conditions for the one or more high integrity applications, the set of operating conditions being different for each high integrity application of the one or more high integrity applications.

In some embodiments, the application selector may be configured to dynamically select at least one high integrity application of the one or more high integrity applications based on at least one of one or more operating conditions, one or more sets of integrity assessment data, one or more sets supporting data, the one or more commands received from the one or more upper functional layers, or the one or more status outputs received from the one or more lower functional layers, the selected high integrity application dynamically selected by the application selector being the high integrity application that is configured to provide the best performance while maintaining integrity and fault tolerance.

In some embodiments, the plurality of applications may include one or more high performance applications and a high integrity back-up application.

In some embodiments, each functional layer of the plurality of functional layers may further include: a safety monitor configured to raise one or more safety alerts based on at least one of one or more operating conditions, one or more sets of integrity assessment data, one or more sets of supporting data, one or more commands received from the one or more upper functional layers, or the one or more status outputs received from the one or more lower functional layers, the safety monitor further configured to clear the one or more safety alerts; and a switch configured to switch between the one or more high performance applications and the high integrity back-up application when a safety alert of the one or more safety alerts is raised, the switch further configured to switch between the one or more high performance applications and the high integrity back-up application when a safety alert of the one or more safety alerts is cleared.

In some embodiments, each functional layer of the plurality of functional layers may further include: a safety monitor configured to raise one or more safety alerts based on at least one of one or more operating conditions, one or more sets of integrity assessment data, one or more sets of supporting data, one or more commands received from the one or more upper functional layers, or the one or more status outputs received from the one or more lower functional layers, the safety monitor further configured to clear the one or more safety alerts, the application selector being configured to switch between the one or more high performance applications and the high integrity back-up application when a safety alert of the one or more safety alerts is raised, the application selector further configured to switch between the high integrity back-up application and the one or more high performance applications when a safety alert of the one or more safety alerts is cleared by the safety monitor.

In some embodiments, the system may further include one or more operator output interfaces configured to display the one or more status outputs.

In some embodiments, each upper functional layer of the one or more upper functional layers may be configured to monitor one or more characteristics of the one or more lower functional layers, the one or more lower functional layers being configured to provide a lower level of automation than each upper functional layer of the one or more upper functional layers.

A multi-agent hierarchy automation system is disclosed, in accordance with one or more embodiments of the disclosure. In one embodiment, the system includes one or more operator input interfaces configured to receive one or more operator commands from an operator. In another embodiment, the system includes a hierarchy of a plurality of functional layers configured to perform one or more functions in response to the received one or more operator commands, the hierarchy of the plurality of functional layers including a first set of a plurality of functional layers and at least an additional set of a plurality of functional layers, the first set of the plurality of functional layers including one or more upper functional layers and one or more lower functional layers, the one or more upper functional layers configured to provide a greater level of automation than the one or more lower functional layers, the additional set of the plurality of functional layers including one or more upper functional layers and one or more lower functional layers, the one or more upper functional layers configured to provide a greater level of automation than the one or more lower functional layers. In another embodiment, each functional layer of the plurality of functional layers includes a plurality of applications. In another embodiment, each functional layer of the plurality of functional layers includes an arbitrator configured to dynamically select an appropriate input source for the plurality of applications. In another embodiment, each functional layer of the plurality of functional layers includes an application selector configured to dynamically select an application of the plurality of applications to perform the one or more functions. In another embodiment, each functional layer of the plurality of functional layers includes a default safe fallback module configured to selectively provide a substantially safe operation for each functional layer of the plurality of functional layers to perform.

In another embodiment, each upper functional layer of the one or more upper functional layers of the first set of the plurality of functional layers is configured to dynamically provide one or more commands to at least one of a lower functional layer of the one or more lower functional layers of the first set of the plurality of functional layers, a lower functional layer of the one or more lower functional layers of the at least one additional set of the plurality of functional layers, or an equivalent upper functional layer of the at least one additional set of the plurality of functional layers, each lower functional layer of the one or more layer functional layers of the first set and the at least one additional set of the plurality of functional layers being configured to provide a lower level of automation than each upper functional layer of the one or more upper functional layers of the first set of the plurality of functional layers, the equivalent upper functional layer of the at least one additional set of the plurality of functional layers being configured to provide a substantially similar level of automation as the upper functional layer of the one or more upper functional layers of the first set of the plurality of functional layers. In another embodiment, each lower functional layer of the one or more lower functional layers of the first set of the plurality of functional layers is configured to provide one or more status outputs to each upper functional layer of the one or more upper functional layers of the first set of the plurality of functional layers, each upper functional layer of the one or more upper functional layers of the first set of the plurality of functional layers being configured to provide a greater level of automation than each lower functional layer of the one or more lower functional layers of the first set of the plurality of functional layers. In another embodiment, each lower functional layer of the one or more lower functional layers of the at least one additional set of the plurality of functional layers is configured to provide one or more status outputs to each upper functional layer of the one or more upper functional layers of the at least one additional set of the plurality of functional layers, each upper functional layer of the one or more upper functional layers of the at least one additional set of the plurality of functional layers being configured to provide a greater level of automation than each lower functional layer of the one or more lower functional layers of the at least one additional set of the plurality of functional layers. In another embodiment, each lower functional layer of the one or more lower functional layers of the at least one additional set of the plurality of functional layers is configured to provide one or more status outputs to at least one of an upper functional layer of the one or more upper functional layers of the first set of the plurality of functional layers or an equivalent lower functional layer of the first set of the plurality of functional layers, the equivalent lower functional layer of the first set of the plurality of functional layers being configured to provide a substantially similar level of automation as the lower functional layer of the one or more lower functional layers of the at least one additional set of the plurality of functional layers.

In some embodiments, the plurality of applications may include one or more high integrity applications configured to provide high integrity behavior, the high integrity behavior being configured to provide a substantially safe operation within a set of operating conditions for the one or more high integrity applications, the set of operating conditions being different for each high integrity application of the one or more high integrity applications.

In some embodiments, the application selector may be configured to dynamically select at least one high integrity application of the one or more high integrity applications based on at least one of one or more operating conditions, one or more sets of integrity assessment data, one or more sets supporting data, the one or more commands received from the one or more upper functional layers, or the one or more status outputs, the selected high integrity application dynamically selected by the application selector being the high integrity application that is configured to provide the best performance while maintaining integrity and fault tolerance.

In some embodiments, the plurality of applications may include one or more high performance applications and a high integrity back-up application.

In some embodiments, each functional layer of the plurality of functional layers may further include: a safety monitor configured to raise one or more safety alerts based on at least one of one or more operating conditions, one or more sets of integrity assessment data, one or more sets of supporting data, the one or more received commands, or the one or more received status outputs, the safety monitor further configured to clear the one or more safety alerts; and a switch configured to switch between the one or more high performance applications and the high integrity back-up application when a safety alert of the one or more safety alerts is raised, the switch further configured to switch between the one or more high performance applications and the high integrity back-up application when a safety alert of the one or more safety alerts is cleared by the safety monitor.

In some embodiments, each functional layer of the plurality of functional layers may further include: a safety monitor configured to raise one or more safety alerts based on at least one of one or more operating conditions, one or more sets of integrity assessment data, one or more sets of supporting data, one or more received commands, or one or more received status outputs, the safety monitor further configured to clear the one or more safety alerts, the application selector being configured to switch between the one or more high performance applications and the high integrity back-up application when a safety alert of the or more safety alerts is raised, the application selector further configured to switch between the high integrity back-up application and the one or more high performance applications when a safety alert of the one or more safety alerts is cleared by the safety monitor.

A method for hierarchical automation is disclosed, in accordance with one or more embodiments of the disclosure. In one embodiment, the method includes, but is not limited to, receiving one or more commands from an operator. In another embodiment, the method includes, but is not limited to, providing the one or more commands to a plurality of functional layers, the plurality of functional layers including one or more upper functional layers and one or more lower functional layers, the one or more upper functional layers configured to provide a greater level of automation than the one or more lower functional layers. In another embodiment, the method includes, but is not limited to, performing the one or more functions in response to the one or more received commands. In another embodiment, the method includes, but is not limited to, generating upper layer output data using the one or more upper functional layers. In another embodiment, the method includes, but is not limited to, providing the upper layer output data to at least one lower functional layer of the one or more lower functional layers, each lower functional layer of the one or more lower functional layers configured to provide a lower level of automation than each upper functional layer of the one or more upper functional layers. In another embodiment, the method includes, but is not limited to, generating lower layer output data using the one or more lower functional layers. In another embodiment, the method includes, but is not limited to, providing the lower layer output data to each upper functional layer of the one or more upper functional layers, each upper functional layer of the one or more upper functional layers configured to provide a greater level of automation than each lower functional layer of the one or more lower functional layers. In another embodiment, the method includes, but is not limited to, providing at least one of the upper layer output data or the lower layer output data to one or more operator interfaces.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a simplified schematic of a hierarchical automation system, in accordance with one or more embodiments of the disclosure;

FIG. 2 illustrates a simplified schematic of a multi-agent hierarchical automation system, in accordance with one or more embodiments of the disclosure;

FIG. 3A illustrates a simplified schematic of a functional layer within the plurality of functional layers of the hierarchical automation system, in accordance with one or more embodiments of the disclosure;

FIG. 3B illustrates a simplified schematic of a functional layer within the plurality of functional layers of the hierarchical automation system, in accordance with one or more embodiments of the disclosure;

FIG. 3C illustrates a simplified schematic of a functional layer within the plurality of functional layers of the hierarchical automation system, in accordance with one or more embodiments of the disclosure; and

FIG. 4 illustrates a flow diagram depicting a method or process for the hierarchical automation system, in accordance with one or more embodiments of the disclosure.

### DETAILED DESCRIPTION OF THE INVENTION

Reference will now be made in detail to the subject matter disclosed, which is illustrated in the accompanying drawings.

Before explaining one or more embodiments of the disclosure in detail, it is to be understood the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

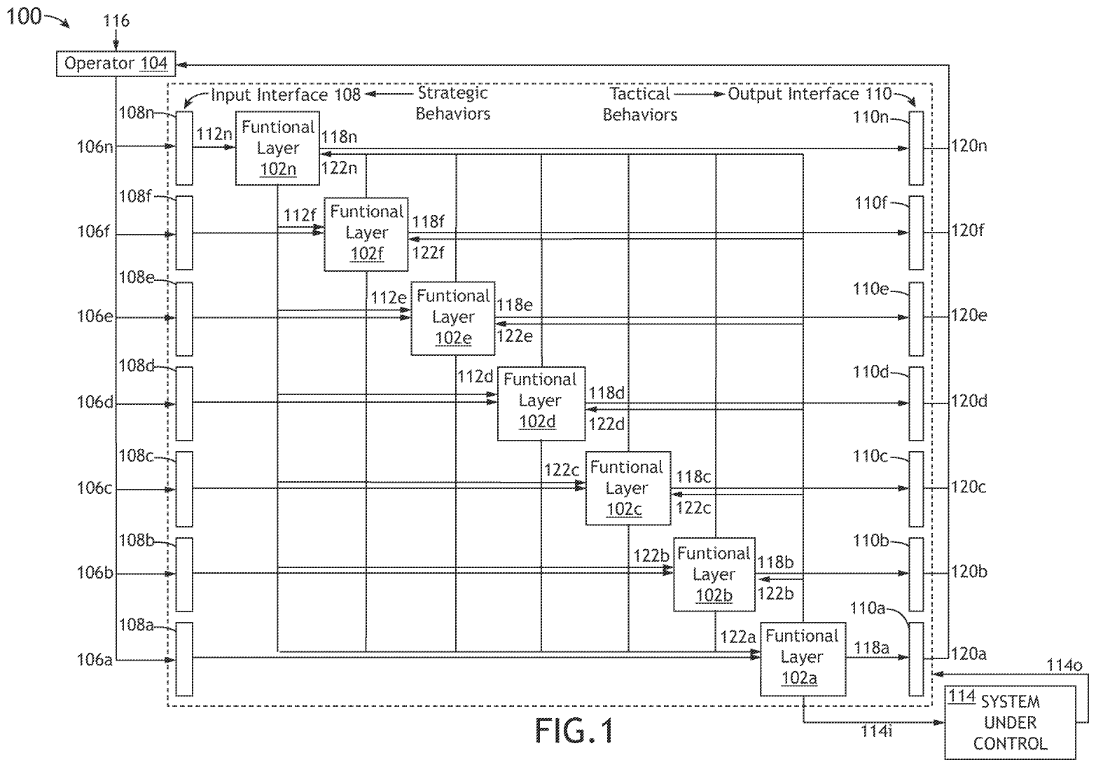

FIGS. 1-4 generally illustrate a hierarchical automation system and method for autonomous aerial vehicles, in accordance with one or more embodiments of the disclosure.

Autonomous systems must be able to adapt quickly to emerging and evolving technological and strategic threats. In the military sector, as missions and threats evolve, there is an increased need for systems with higher degrees of autonomous decision making capabilities and reduced operator workload. In the commercial and civil aviation sectors, there is need for increased flight autonomy in order to minimize pilot workload and to safely enable reduced crew operations. This may include single pilot operations or even no pilot operations (the latter of which may be associated with initiatives like Urban Air Mobility). However, current autonomous systems and other like control-intensive software architectures are traditionally highly complex and interconnected, which precludes easy and/or inexpensive modular upgrades to such systems.

From a user-system interaction perspective, there is also a strong desire to make a shift from a user-in-the-loop (e.g., operator) to a user-on-the-loop (e.g., supervisor) perspective. Given this, there is a need for an architectural framework that binds various automation capabilities together in an organized, consistent, and modular way.

Further, the uses of autonomous systems are becoming increasingly diverse. Therefore, while a user may nominally interact with such a system in a supervisorial capacity, the user may want to dynamically change their command and control perspective as an operation progresses. Deploying systems with open interfaces and architectures that allow for interoperability through many different layers of abstraction for command and control can allow for this desired flexibility. This becomes especially important in cases where a user wants to assume low-level control of a system to fine-tune actions at critical moments or when investigating or diagnosing system failures. Current systems, in both the commercial and military sector, are often overloaded with extraneous functionality, plagued by behemoth state machines, and often complicated beyond reason, which blurs the lines between their roles and capabilities, and often makes feature updates to them both cost and schedule prohibitive.

In order to satisfy the aforementioned needs and enable systems to employ advanced automation and autonomy features, a reference architecture is needed that provides a clear organization for the functionality of an autonomous system that ranges from low-level actuator/servomechanism control all the way up to the high levels of autonomy required for mission management and coordination of multi-vehicle teams. Doing so not only has organizational benefits for system components and applications (e.g., minimizing interdependencies, providing a “separation of concerns”, and the defining of their roles and interactions within the system), but also serves as the basis for the development of flexible software integration frameworks, intuitive human/machine interfaces, standardized messaging/communication protocols between with and within the system, and fault tolerant architectures that provide run time assurance throughout the system.

Embodiments of the present disclosure are directed to a hierarchical automation system configured to provide a modular and interoperable way to construct automation systems. More particularly, embodiments of the present disclosure are directed to a hierarchical automation system including a plurality of functional layers with increasing levels of automation/abstraction. Each functional layer of the plurality of functional layers may be configured to perform one or more autonomous functions, such that an autonomous system is able to move and maneuver in response to one or more commands. Further, each functional layer of the plurality of functional layers may include a substantially similar structure which reduces the complexity of the overall system and provides a novel and modular run time assurance (RTA) architecture for the system.

FIGS. 1-3C in general illustrate a hierarchical automation system 100, in accordance with one or more embodiments of the disclosure.

### FIG. 1—System Overview

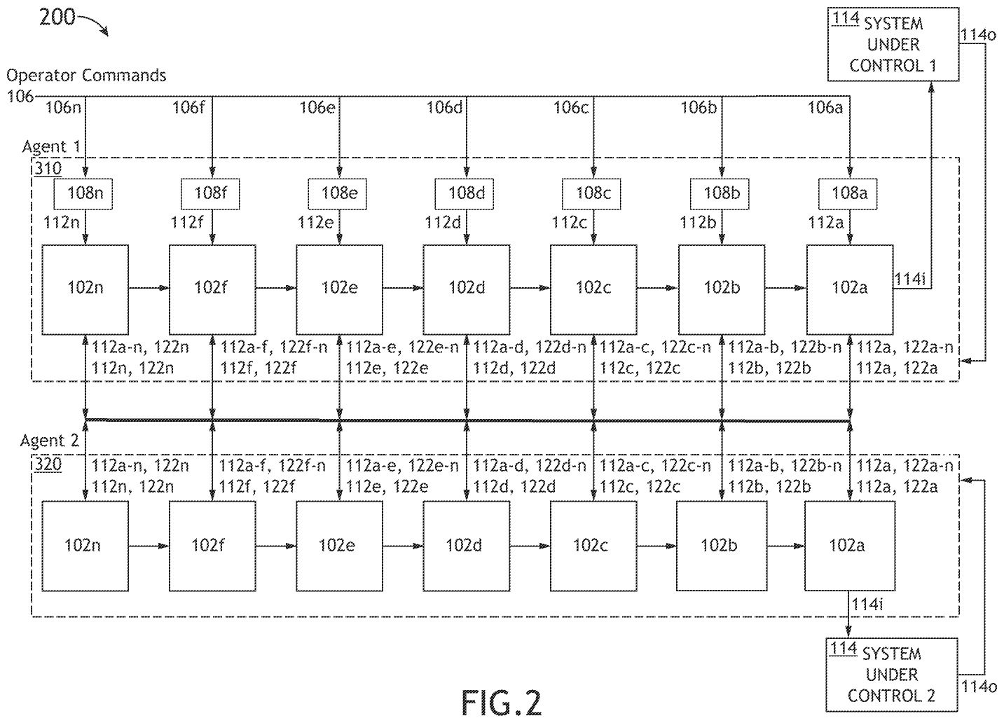

The hierarchical automation system 100 may include a hierarchy of a plurality of functional layers 102 with increasing levels of automation/abstraction. For example, the system 100 may include one or more upper functional layers and one or more lower functional layers. The one or more upper functional layers may be configured to provide a greater level of automation than one or more lower functional layers. For purposes of the present disclosure, directional terms such as “greater”, “lesser”, “upper”, “higher”, “lower”, “above”, and “below” as used herein are intended to provide relative positions for purposes of description, and are not intended to designate an absolute frame of reference. Further, for purposes of the present disclosure, the term upper layer is intended to designate a functional layer having a greater level of automation than a lower layer and the term lower layer is intended to designate a functional layer having a lower level of automation than a upper layer. Further, it is noted herein that although FIGS. 1-2 illustrate the system 100,200 including a specific number of layers 102a-102n, the system 100, 200 may include up to an N number of layers 102 configured in a hierarchy, where N may be more or less than the specific number of layers depicted in the system 100, 200.

The plurality of functional layers 102 may include varying levels of abstraction with the level of abstraction increasing in an upward direction towards the top of the hierarchy of layers. For example, as shown in FIG. 1, the top most layer (e.g., layer 102n) may provide the highest level of automation and the bottom most layer (e.g., layer 102a) may provide the lowest level of automation. The layers positioned between such layers (e.g., layers 102f-102b) may provide intermediate levels of abstraction, with the layers positioned closer to the top most layer (e.g., layer 102n) having a greater levels of abstraction than the layers positioned closer to the bottom most layer (e.g., layer 102a). For example, the functional layer 102n may provide a greater level of automation than the layers 102f-102a having lower levels of automation than the functional layer 102n. By way of another example, the functional layer 102f may provide a greater level of automation than layers 102e-102a having lower levels of automation than the functional layer 102f. By way of further examples, the functional layer 102e may provide a greater level of automation than layers 102d-102a; the functional layer 102d may provide a greater level of automation than layers 102c-102a; the functional level 102c may provide a greater level of automation than layers 102b-102a; and the functional layer 102b may provide a greater level of automation than layer 102a, with the layer 102a providing the lowest level of automation for the system.

Each functional layer 102a-102n of the plurality of functional layers 102 may be configured to perform one or more functions associated with moving or maneuvering a system under control 114 in response to one or more issued operator commands 106a-106n. As non-limiting examples, such systems under control 114 may include, but not limited to, one or more aerial vehicles, one or more ground vehicles, one or more underwater vehicles, or any associated payload system that can be dynamically moved or maneuvered in order to satisfy some operational goal. The level of abstraction/automation of each layer 102a-102n may be determined based on the one or more functions each layer is configured to perform. For example, in a non-limiting example, the layer 102n may include a mission coordination layer 102n configured to perform one or more mission coordination functions, and the layer 102a may include an actuator control layer 102a configured to perform one or more actuator control functions. In this instance, the one or more mission coordination functions may require a higher level of abstraction/automation than the one or more actuator control functions, such that the mission coordination layer 102n provides a greater level of automation than the actuator control layer 102a.

Continuing with the above example and considering the system under control 114 to be an air or ground vehicle, several intermediate automation layers may be utilized in order to bridge the gap between mission coordination layer 102n and actuator control layer 102a. In this example, the layer 102f may include a task allocation layer 102f configured to perform one or more task allocation functions. In this instance, the one or more mission coordination functions may require a higher level of abstraction/automation than the one or more task allocation functions, such that the mission coordination layer 102n provides a greater level of automation than the task allocation layer 102f. Further, the one or more task allocation functions may require a higher level of abstraction/automation than the one or more actuator control functions, such that the task allocation layer 102f provides a greater level of automation than the actuator control layer 102a.

Continuing further with the example, in an analogous way, the layer 102e may include a route management layer 102e configured to perform one or more route management functions; the layer 102d may include a trajectory planning layer 102d configured to perform one of more trajectory planning functions; the layer 102c may include a tactical control layer 102c configured to perform one or more tactical control functions; and the layer 102b may include a flight control/platform stabilization layer 102b configured to perform one or more flight control or platform stabilization functions. In this instance, each one of these functions performed by layers 102b-102e may require a higher level of abstraction/automation than the functions performed by the layers with lower levels of automation and analogously, the functions performed by each of the layers higher than the layers 102b-102e themselves may require a higher level of abstraction than the layers 102b-102e themselves. For example, the functions of layer 102n and layer 102f may require a higher level of abstraction/automation than those of layer 102e and the functions of layer 102e may require a higher level of abstraction/automation than those of layer 102a, such that layers 102n,102f provide greater levels of automation than layer 102e and layer 102e provides a greater level of automation than layer 102a; the functions of layers 102n, 102f, 102e may require a higher level of abstraction/automation than those of layer 102d, and the functions of layer 102d may require a higher level of abstraction/automation than those of layer 102a, such that the layers 102n, 102f, 102e provide greater levels of automation than layer 102d and layer 102d provides a greater level of automation than layer 102a; the functions of layers 102n, 102f, 102e, 102d may require a higher level of abstraction/automation than those of layer 102c, and the functions of layer 102c may require a higher level of abstraction/automation than those of layer 102a, such that the layers 102n, 102f, 102e, 102d provide greater levels of automation than layer 102c and layer 102c provides a greater level of automation than layer 102a; and the functions of layers 102n, 102f, 102e, 102d, 102c may require a higher level of abstraction/automation than those of layer 102b, and the functions of layer 102b may require a higher level of abstraction/automation than those of layer 102a, such that the layers 102n, 102f, 102e, 102d, 102c provide greater levels of automation than layer 102b and layer 102b provides a greater level of automation than layer 102a.

The layer 102a may include an actuator control layer 102a configured to perform one or more actuator control functions. In this instance, each of the one or more functions performed by layers 102n-102n may require a higher level of abstraction/automation than the one or more actuator control functions, such that layers 102b-102n provide greater levels of automation than the actuator control layer 102a. Further, the one or more actuator control functions may require a lower level of abstraction/automation than any other layer (e.g., layers 102b-102n).

The system 100 may include one or more operator input interfaces 108 configured to receive one or more operator commands 106 from an operator 104. For example, the one or more operator input interfaces 108 may include one or more selectable buttons, keyboard inputs, selectable touchscreen items, or similar human/machine interface (HMI) input mechanisms. For example, the operator 104 may be include, but is not required to include, a human in one embodiment, an artificially intelligent (AI) agent, an automated decision-making agent, or the like. For instance, when the operator is an AI agent, the one or more operator input interfaces 108 may include, but are not required to include, one or more software or hardware mechanisms for an artificial pilot machine interface (APMI).

Each functional layer of the plurality of functional layers 102 may provide the one or more operator input interfaces 108, such that the operator 104 may issue one or more commands 106 to the plurality of functional layers 102. For example, in a non-limiting example, the operator 104 may issue a mission coordination command 106n to the mission coordination layer 102n using a mission coordination input interface 108n. In this regard, the mission coordination interface 108n may be configured to convert the one or more mission coordination commands 106n into an analogous mission coordination commands 112n for an input into the functional layer 102n. Similarly, the operator 104 may then issue an actuator control command 106a to the actuator control layer 102a using an actuator control input interface 108a. In this regard, each layer of the plurality of layers 102a-102n may be control its own interface with dedicated layer inputs 112a-112n and operator interfaces 108a-108n that facilitate the operator's input of commands 106a-106n.

The one or more operator input interfaces 108 thereby enable the operator 104 to alter operator control perspective with the system under control 114 dynamically and in real time by inputting different input commands 106 at different moments in time. This enables the operator to provide commands to the system at different levels of abstraction at different times throughout an operation as needed. As a non-limiting example, the operator 104 may provide an initial mission coordination command 106n to the system at the start of an operation using the interface 108n. Then, at some later point during an operation, an operational need may cause the operator 104 to want to interact with the system under control 114 at a lower or more granular level of abstraction by specifying a tactical control command 106c to the layer 102c through the interface 108c. At another point in the operation, the user may notice a failure or issue with the system under control 114 through the output interface 110 and may want to diagnose it by specifying an actuator control command 106a to layer 102a through the interface 108a. In this example, the actuator control command 106a represents the most granular level of control the operator 104 is capable of with the system under control 114. Lastly, when the situation (failure/issue) has been resolved, the operator 104 may then return to interacting with the system under control 114 at a high level of abstraction by issuing another mission coordination command 106n using the interface 108n and allowing the hierarchy of layers 102a-102n to automate the control of the system under control 114 subject to the commands 106n. In this regard, the operator 104 is able to issue commands at varying levels of granularity based on their evolving needs in time, which are informed by either layer feedback/status outputs 118a-118n or external stimuli 116.

Because the level of automation differs between each layer, the operator 104 may be able to act in a supervisory role (e.g., human-on-the-loop operation) when issuing the high-level commands (e.g., mission coordination commands 106n) to the high-level layers (e.g., the mission coordination layer 102n). Alternatively, the operator 104 may then issue one or more lower level commands (e.g., actuator control commands 106a, tactical control commands 106c, or the like) to one or more lower level layers (e.g., actuator control layer 102a, tactical control layer 102c, or the like) if the operator 104 chooses to do so. In this regard, the operator 104 is able to switch operations from a human-on-the-loop operation to a human-in-the-loop operation when necessary, commanding the system at low or intermediate levels of control as needed. Further, the operator 104 is able to switch operations from a human-in-the-loop operation to a human-on-the-loop operation when necessary, returning to commanding the system at high levels of control as needed.

Each layer may be configured to generate output data. The output data may be standardized to conform to open interface and modular open systems architecture standards and/or be formatted for use with a standardized messaging protocol within the system 100. For example, regardless of the core content of the output data, the output data may further be appended with, but is not limited to, source system/vehicle unique identifier, source layer, destination system/vehicle identifier, destination layer, message type identifier, urgency/priority characteristics, and the like.

Each functional layer of the plurality of layers may generate output control data 112 (e.g., control commands) that may be provided to subsequent layers in the hierarchy in a ladder sense (e.g., from top to bottom) utilizing functions within each layer, such that each layer may be configured to provide output data to one or more layers with lower levels of automation (e.g., layers positioned below the current layer). For example, each functional layer of the one or more functional layers may be configured to provide output data to each lower functional layer of the one or more lower functional layers having a lower level of automation. For example, in a non-limiting example, the operator 104 may provide a mission command 106n through the operator interface 108n to layer 102n, which gets distilled in to a task command 112f for the asset (by the Mission Coordination layer 102n), which then gets broken down and allocated as goals, targets, or areas of interest. 112e (by the Task Allocation 102f), which then gets planned into strategic routes 112d (by the Route Management layer 102e), which then gets refined into dynamically feasible trajectories 112c (by the Trajectory Planning layer 102d), which then gets tracked by the vehicle (through the remainder of the control hierarchy including the Tactical Control layer 102c, the Flight Control layer 102b, and the Actuator Control layer 102a), ultimately getting provided as actuation input commands 114i for System Under Control 114.

In some embodiments, one or more layers within the hierarchy may be bypassed. For example, one task may be short in nature and therefore does not require a route, thereby bypassing the Route Management layer 102e as a result. In such a case, the Task Allocation layer 102f may instead issue commands directly to layers 102a-102d as necessary. For instance, the layer 102f may provide one or more commands 112d to the layer 102d, the layer 102f may provide commands 112c to the layer 102c, the layer 102f may provide commands 112b to the layer 102b, or the layer 102f may provide commands 112a to the layer 102a as appropriate. Although FIG. 1 illustrates a specific architecture with all layers being able to send commands to those below, it is noted herein that the system 100 may include an architecture organized in a more classical ladder arrangement with all commands bypassing through the layers instead of around them.

Each layer of the plurality of layers 102a-102n may be configured to determine when to provide to output data (e.g., control commands) to the respective layers and to which layer to provide the output data (e.g., control commands). For example, each layer may be configured to switch which layer it is issuing commands to as necessary in time depending on the layer's desired granularity of control at a particular moment. In a non-limiting example, the task allocation layer 102f may want to command the route management layer 102e one or more route commands (e.g., chain of waypoints for the vehicle to follow) at one time instance, but demand direct flight control commands (e.g., pitch, roll, heading, vertical speed) to the flight control layer 102b at a different time. In this regard, the layers within the hierarchy are dynamically configurable depending on the nature of the current objective. It is noted herein that the standardized output data format would ensure that there is no ambiguity in the system 100 in terms of which commands are intended for which layers. For example, if the task layer 102f wants to issue commands to the route management layer 102e at one time and the tactical control layer 102c at another time, it may append its messages with some enumeration/header so that the route layer only parses/responds to the commands intended for it and the tactical control layer 102c only parses/responds to the commands intended for it.

Each functional layer of the plurality of functional layers 102a-102n may be configured to perform the one or more functions in response to the issued operator command 106a-106n (converted into layer input commands 112a-112n through the operator interface 108a-108n). The one or more commands 106a-106n issued to the various layers may differ for each layer. For example, the mission coordination commands 106n may include, but are not limited to, mission objectives commands, mission threats, and the like. By way of another example, the task allocation commands 106f may include, but are not limited to, individual or team tasking commands, instruction sets, and the like. By way of another example, the route management commands 106e may include, but are not limited to, points or areas of interest to investigate, goal locations or static/dynamic targets to maneuver to, target commands, and the like. By way of another example, the trajectory planning commands 106d may include, but are not limited to, route commands, waypoint commands, maneuvering targets to pursue, and the like. By way of another example, the tactical control commands 106c may include, but are not limited to, desired kinematically or dynamically feasible trajectories, path deviations, autopilot mode requests, and the like. By way of another example, the flight control commands 106b may include, but are not limited to, attitude or attitude rate commands, acceleration commands, vertical speed commands, airspeed/groundspeed commands, autopilot mode commands, and the like. By way of another example, the actuator control commands 106a may include, but are not limited to, direct actuator commands, effective control surface commands (e.g. an effective “aileron” command when a system under control 114 has an actuation topology that may multiple ailerons, flaps, v-tail, etc.), and the like.

Each layer 102a-102n may be configured to provide the generated operator output data 118 for use as feedback to the operator 104. The output data may include, but is not limited to, statuses, alerts, command echoes, situational awareness information, and the like. In a non-limiting example, the operator output data 118a of functional layer 102a may provide information relevant to monitoring of actuator control performance, whereas the operator output data 118c of functional layer 102c may provide information relevant to monitoring of tactical control performance. The system 100 may include one or more operator output interfaces 110a-110n configured to display the operator output data of the various layers 118a-118n, converting the data into a data or display format consumable by the operator 120a-120n. For example, the one or more output interfaces 110a-110n may display output data of each layer, such that the operator 104 is able to make decisions based on the output data of each layer. In this regard, the operator 104 may be able dynamically select which layer's output data to monitor throughout the operation.

Each layer 102a-102n may be configured to provide output data to one or more layers with greater levels of automation than the current layer 122. For example, each lower functional layer of the one or more lower functional layers may be configured to provide output data to each upper functional layer of the one or more upper functional layers with greater levels of automation than the lower functional layer. For instance, the tactical control layer 102c may provide output data 122d to the trajectory planning layer 102d. In this regard, if the tactical control layer 102c is having difficulty tracking a path, the trajectory planning layer 102d may receive the output data 122d indicating such an issue and may subsequently provide an alternate path to follow.

As a further example, the tactical control layer 102c may provide output data 122f to the task allocation layer 102f. In this regard, if the tactical control layer 102c is having difficulty tracking a path, and if accurately tracking that path is a key metric to successful task completion, the task allocation layer 102f may receive the output data 122f indicating such an issue and may subsequently reallocate its tasks and provide an alternate task to perform. Further examples could be described for further combinations (e.g., the layer 102a providing output data 122b-122n to layers 102b-102n, the layer 102b providing output data 122c-122n to layers 102c-102n, the layer 102c providing output data 122d-122n to layers 102d-102n, and so on up the hierarchy).

In order to generate output data, each functional layer may be configured to sense one or more sets of output data 114o from the System Under Control 114. It is noted herein that the arrow 114 is intended to depict sensed, perceived, or communicated output data 114o from the system 114 and the output data 114o may be available to all layers in the hierarchy (although not shown for simplicity) as needed for performing their functions, generating output commands 112a-112f for subsequent layers or the system under control 114, generating output data 118a-118n for the operator, and/or providing output data for other layers in the hierarchy 122b-122n.

It is noted herein that the operator 104 and the operator interface 108, 110 may include any operator and interface suitable for issuing commands and displaying output data. For example, the operator 104 may include, but is not required to include, a human operator, artificial intelligence (AI) operator, a remote operator, and the like. For instance, the one or more operator interfaces 108, 110 may include, but is not required to include, a human/machine interface (HMI), an artificial pilot machine interface (APMI), an interactive display system, and the like.

### FIG. 2—Multi-Agent System Overview

FIG. 2 illustrates a multi-agent hierarchical automation system 200, in accordance with one or more embodiments of the disclosure. The hierarchical automation system 100 (as shown in FIG. 1) may be adapted for a multi-agent system 200. It is noted herein that any discussion with respect to one or more components of system 100 may be applied to one or more components of system 200, and vice versa.

The hierarchical automation system 100 may be integrated within a plurality of systems under control 114, such that the automation system 100 is a multi-agent hierarchical system 200. For example, the system 200 may include a lead autonomous vehicle 310 and one or more follower autonomous vehicles 320. By way of another example, the system 200 may include a team of one or more vehicles 310, 320, where the vehicle 310 is the vehicle that receives the command from the operator. Each vehicle 310, 320 may include a plurality of layers 102a-102n. The plurality of layers 102a-102n may have increasing levels of abstraction/automation as you move towards to left-hand side of FIG. 2 (rather than as you move up in FIG. 1).

The lead vehicle 310 and the one or more follower vehicles 320 may be communicatively coupled, such that the lead vehicle 310 and the one or more follower vehicles 320 are in communication. The one or more follower vehicles 320 may be communicatively coupled to each other, such that the follower vehicles are all in communication with each other.

The operator 104 may be configured to issue one or more commands 106a-106n to the plurality of layers 102a-102n of the lead vehicle 310 using the one or more operator interfaces 108a-108n. For example, in a non-limiting example, an operator 104 may be configured to provide a task command 106f to the task allocation layer 102f of the lead vehicle 310. The lead vehicle 310 may then be configured to distill the task command into a set of route management commands 112e for each follower of the one or more follower vehicles 320. In this regard, the task allocation layer 102f of the lead vehicle 310 may be configured to output the route management commands 112e and provide the route management commands 112e to the route management layer 102e of the one or more follower vehicles 320.

By way of another example, in a non-limiting example, an operator 104 may be configured to provide a task command 106f to the task allocation layer 102f of the lead vehicle and the task layer 102f of the lead vehicle 310 may be configured to break the task command 106f into sub-tasks. The task layer 102f of the lead vehicle 310 may then issues those sub-tasks to the task layers 102f of its teammate aircraft 320. Unlike system 100, in system 200 the functional layers 102a-102n at each level in the hierarchy may be configured to provide commands 112a-112n and output data 122a-122n to functional layers of other agents at the same level in the hierarchy (e.g., the layer 102f of the agent 310 may communicate with the layer 102f of the agent 320).

By way of a further example, in a non-limiting example, an operator 104 may be configured to provide a trajectory command 106c to the trajectory layer 102c of the lead vehicle and the trajectory layer 102c of the lead vehicle 310 may be configured to break the trajectory command 106c into trajectory segments to split amongst the vehicle team. The trajectory layer 102c of the lead vehicle 310 may then issue those trajectory segments to the trajectory layer 102c of its teammate aircraft 320. In this regard, each subordinate (follower) aircraft 320 flies along the trajectory piece/segment.

Although the above discussion refers to leader/follower scenario, it is noted herein that the system 200 may also support the cooperative (leaderless) case where all agents (followers) are peers. For example, an operator 104 may be configured to provide a trajectory to the agent team 310,320. The trajectory layers 102d of each agent may then be configured to send commands to each other to coordinate which vehicle follows which portion of the trajectory.

It is noted herein that with this multi-agent architecture, the system is configured to support supporting an interconnected system of systems (collection of agents each utilizing this system) with dynamic levels of interoperability between agents.

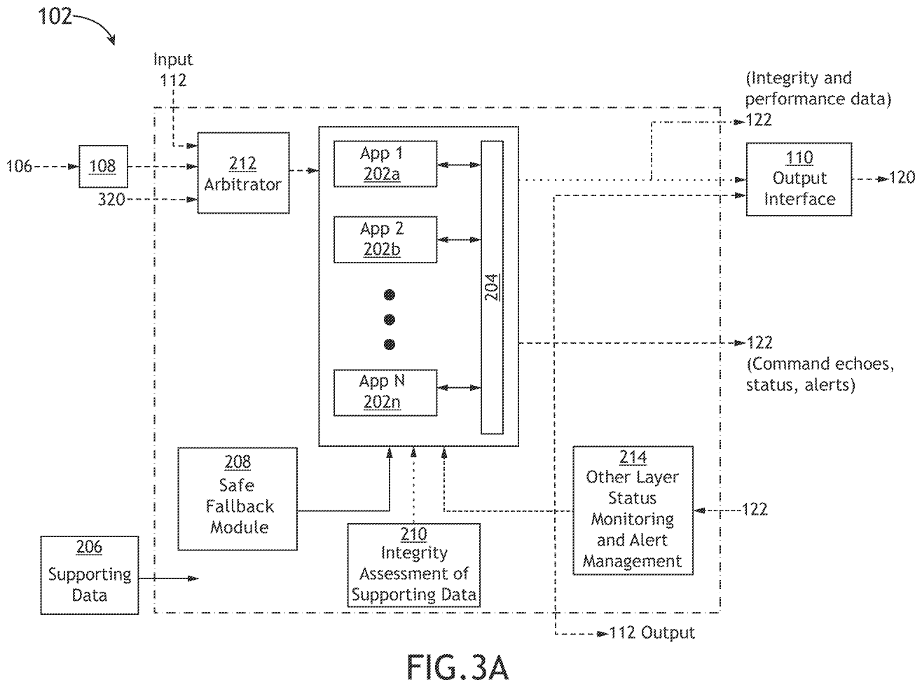

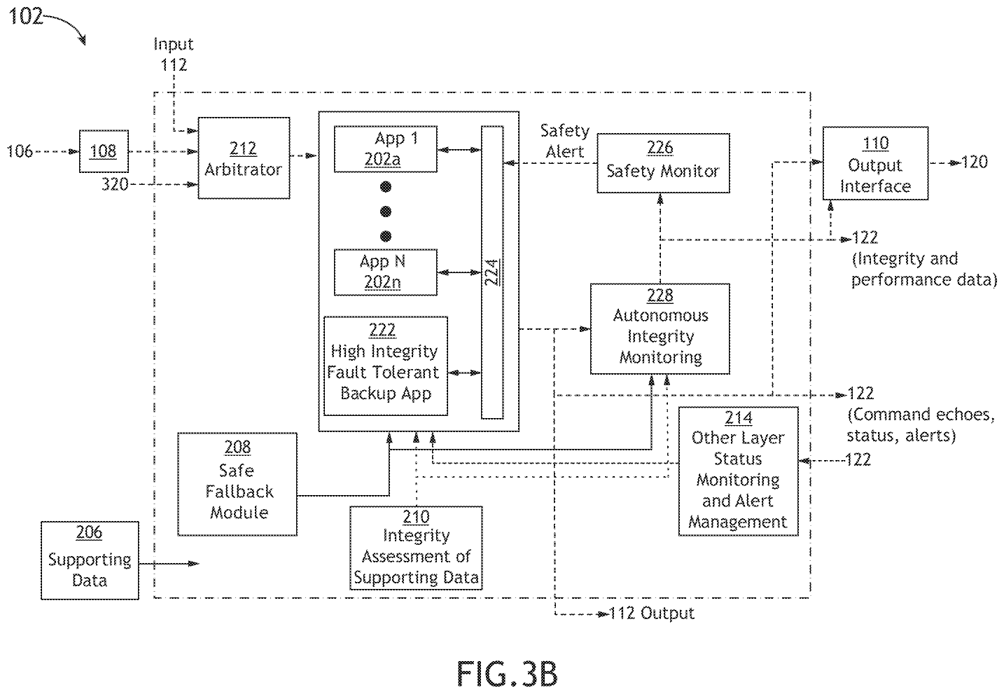

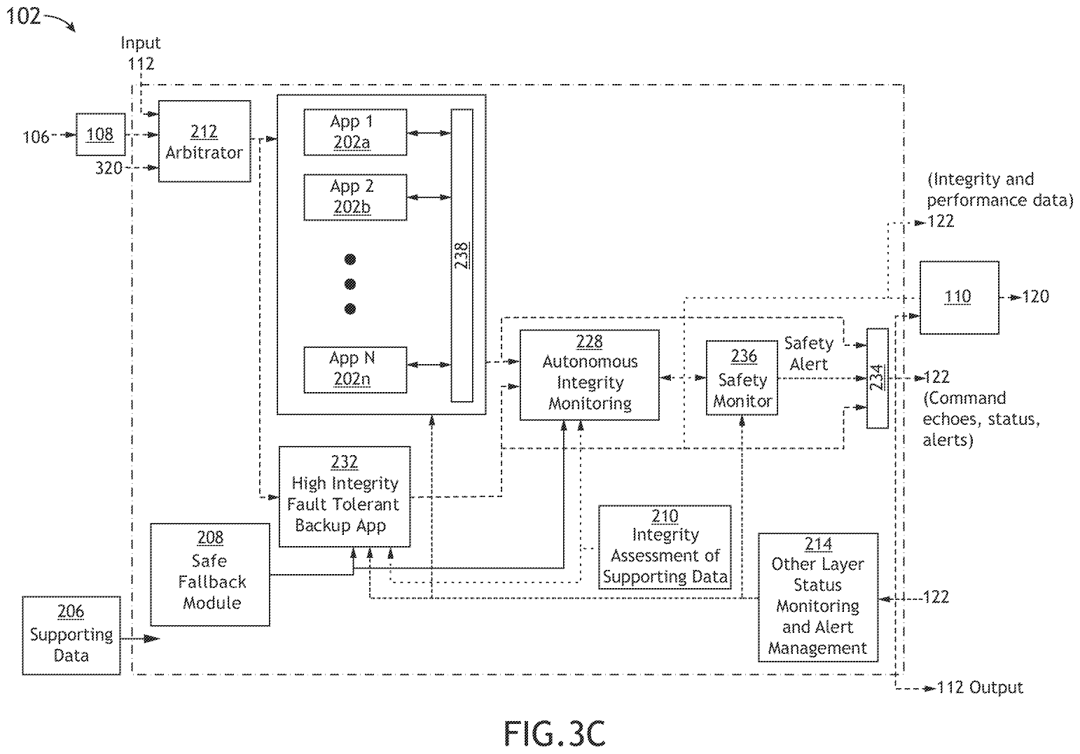

### FIGS. 3A-3C—Functional Layer Architecture Details

FIGS. 3A-3C illustrate simplified schematics of a functional layer 102 in the hierarchy of layers 102a-102n, in accordance with one or more embodiments of the disclosure. Each layer of the plurality of layers may include a substantially similar structure. For example, each layer of the plurality of layers 102 may include substantially similar components, features, and applications which are organized in a substantially similar structure inside the various layers. It is noted herein that with this architecture each layer of the plurality of layers 102 and the components within each layer are able to focus only on that specific layer of abstraction, which reduces the complexity of the overall system and encourages re-usability and modularity.

Referring generally to FIGS. 3A-3C, each layer of the plurality of layers 102 may include a plurality of applications 202a-202n. The applications 202a-202n may be configured to perform one or more primary functions associated with the layers 102a-102n. For example, the applications 202a-202n may be configured to distill or decompose the one or more input commands for that layer (from one or multiple sources including operator commands 106, from an upper layer in the hierarchy 122, or from a hierarchy layer of another cooperating agent 320) into output commands for other hierarchy layers 122, output data for an operator 118, and output data for other layers in the hierarchy 122. In a non-limiting example, the applications 202a-202n in a Trajectory Planning layer 102d may be configured to plan kinematically feasible trajectories 112c to pass through the waypoints 112d specified by the Route Management layer 102e. In this instance, a first application 202a (App 1) may be configured to plan trajectories in a conservative manner using for non-aggressive steering and enhanced ride quality, while a second application 202b (App 2) may be configured to plan aggressive maximum performance paths that are significantly more sporty in nature. Additionally, a third application 202c (App 3) may plan trajectories considering required times of arrival at each waypoint, a fourth application 202d (App 4) may plan trajectories that attempt to achieve the waypoints as best as possible but assuming the presence of a failure or degraded vehicle performance. It is noted herein that additional examples of additional applications 202e-202n (Apps 5 through N) may be described that attempt to achieve the specified waypoints 112d but do so in alternative ways or with alternative assumptions, restrictions, and/or tuning.

In this regard, the plurality of applications 202a-202n may be configured as options for the layer to utilize, each of which may be more beneficial under certain conditions. As shown in FIGS. 3A-3C, each application 202a-202n may be configured to generate one or more control outputs 112, and the selection of which application's outputs proceed out of the layer and down the hierarchy is performed in a dynamic, fault tolerant, and high integrity manner.

Referring generally to FIG. 3A-3C, an input command arbitrator/selector 212 may be configured to prioritize which of the several sources of input commands ultimately get processed by the layer's applications 202a-202n. The input commands may originate from an operator 104 through the interface 108, the output of an upper layer in the hierarchy (e.g., input 112), or the output of a layer in the hierarchy of another cooperating agent 320. The arbitration/selection scheme may be configured to be based on pre-configured priority tables, priority logic software, pre-loaded configuration data, or automatic or artificially intelligent decision making. Regardless of the mechanism, one of the sets of input commands will be selected by the arbitrator 212 at each moment in time.

Each layer 102 of the plurality of layers 102a-102n may include an application selector 204 configured to dynamically select an application of the plurality of applications to perform the one or more functions, which is discussed further herein.

Each layer 102 of the plurality of layers 102a-102n may be configured to perform layer status monitoring/alert management using a component 214. The component 214 may be responsible for processing the layer outputs 122 and flagging issues, failures, or notable indications that impact the current layer based on the output data communicated by other layers.

Each layer 102 of the plurality of layers 102a-102n may be configured to input supporting data 206. This data may include a variety of items that are sensed, perceived, or communicated from the system under control 114 and/or the outside world/environment that the layer 102 requires to perform its functions. The supporting data may include, but is not limited to, sensor inputs, navigation data, 3D world model/common operating picture data, communications link data, timing data, output data from the system under control 114o, and the like. Further, the supporting data 206 may be provided to any of the components indicated in FIG. 3A-3C.

Each layer 102 of the plurality of layers 102a-102 may be configured to have an integrity assessment of supporting data component 210. The component 210 may be responsible for monitoring or analyzing the supporting data 206 for issues, faults, or errors and reporting these to the components indicated in FIG. 3A-3C.

Each layer 102 of the plurality of layers 102a-102n may be configured to have a default safe fallback module 208. The fallback module 208 may be integral to the run-time assurance architecture of the layers 102a-102n and establishes an initial or default behavior to perform from system startup through a defined time horizon. During this time horizon, the various applications and safety monitors may be initializing and/or have not yet calculated their high integrity safe fallback actions, as discussed further herein. The fallback module 208 may be configured to provide an initial safe action for each of the layers 102 of the plurality of layers 102a-102n. Further, the fallback module may be configured to provide an initial safe action (e.g., pre-configured or operator configured) before the remainder of the run-time assurance (RTA) components. Further, the fallback module 208 may be configured to monitor each layer 102 and determine which applications are active and valid. The fallback module 208 may be configured in a variety of ways including, but not limited to, a configuration data file, software logic, or an additional input through a human-machine interface (HMI) or artificial pilot machine interface (APMI).

### FIG. 3A—Example Functional Layer Architecture

Referring to FIG. 3A, the plurality of applications 202a-202n may include a plurality of high performance applications 202a-202n. Each of the high performance applications 202 may be configured to provide high integrity behavior (e.g., fault tolerant action, “guaranteed safe” operation) in a limited portion of the layer's domain (e.g., that layer's flight objective or operating region). In this regard, the plurality of high performance applications 202a-202n are able to provide many safe behaviors in a number of limited areas. For example, in a non-limiting example, for the flight control layer 102b, each high performance application 202a-202n within the flight control layer 102b may be configured to provide high integrity in a specific set of flight envelope conditions, where the specific set of flight envelope conditions of each application may vary. The set of flight envelope conditions may include, but are not limited to, airspeed ranges, bank/pitch angles, altitudes, rotor speed ranges, and the like. In this regard, an application 202a may provide high integrity for airspeed range and an application 202b may provide high integrity for rotor speed ranges.

Each layer of the plurality of layers 102 may include an application selector 204 configured to dynamically select a high performance application 202 of the plurality of high performance applications 202a-202n based on the operating conditions of the automation system and integrity assessment data (e.g., performance metrics, margin, and the like). The application selector 204 may be configured to dynamically select a high performance application based on data provided by the supporting data 206, fallback module 208, integrity assessment component 210, or other layer status component 214. The selected application 202 may be configured to provide one or more output commands as the output commands 112 of the layer 102. In a non-limiting example, the application selector 204 may select the application 202a when the system is in an operating condition where the application 202a provides the highest integrity (e.g., safest proven fallback behavior) for that operating condition. The application selector 204 may select the application 202b when the system is in an operating condition where the application 202b provides the highest integrity behavior, and so on.

Continuing this example, if multiple applications 202a-202n have the same or similar integrity levels, the application selector 204 may be configured to switch between each of the plurality of the high performance applications 202a-202n with the same or similar integrity levels preferring higher performing applications over others. For instance, the application selector 204 may be configured to switch from the high performance application 202a to the high performance application 202b if the application 202b is providing higher performance than the application 202a and the same or similar integrity level.

The application selector 204 may also be configured to perform integrity monitoring based on the integrity assessment when dynamically selecting a high performance application, such that the application that is prioritized (e.g., selected by the application selector 204) is the application that is configured to perform best while maintaining integrity/fault tolerance.

The application selector 204 may be configured to provide the output data to the output interface 110 for that layer. The output data may include the application the application selector 202 dynamically selected and information from the integrity assessment.

### FIG. 3B—Additional Example Functional Layer Architecture

Referring to FIG. 3B, in an alternative embodiment, the plurality of applications may include one or more high performance applications 202a-202n (or one or more low integrity applications) and a single high integrity back-up application 222 within the application bank. The high integrity back up application 222 may be configured to provide an always safe output when a safety alert is raised via the safety monitor 226. The safety monitor 226 may be informed by an autonomous integrity monitoring component 228 configured to monitor the output data of the application selector 224, the integrity assessment component 210 for alerts, errors, issues, or faults.

Each layer of the plurality of layers 102 may include an application selector 224 configured to switch control from one of the high performing applications 202a-202n to the high integrity backup 222 when a safety alert is raised by a safety monitor 226. The safety monitor 226 may be configured to raise a safety alert based on integrity assessment data and integrity monitoring data. When no safety alert is raised, the application selector 224 may select any of the high performance applications 202a-202n via a decision mechanism (e.g., configuration data file, software logic, or similar) that selects the most preferable application dynamically.

For example, the application selector 224 may be configured to switch between the high performance application 202 and the high integrity application 222 when things go bad (e.g., when the system experiences a failure, when the system operating performance is reduced, or the like). For instance, the application selector 224 may be configured to switch from the high performance application 202 to the high integrity application 222 when things go bad. By way of another example, the application selector 224 may be configured to switch between the high integrity application 222 and the high performance application 202 when things are good or the bad situation clears up. For instance, the application selector 224 may be configured to switch from the high integrity application 222 to the high performance application 202 when things are good.

### FIG. 3C—Additional Example Functional Layer Architecture

Referring to FIG. 3C, in alternative/additional embodiments, the plurality of applications may include one or more high performance applications 202a-202n and a high integrity back-up application 232 configured to provide an always safe output when a safety alert is raised by the safety monitor 236. In this embodiment, the high integrity back up application 232 is not included in the application bank (as shown in FIG. 3B). Rather, the high integrity back up application is separate from the high performance applications 202 in the application bank.

Each layer of the plurality of layers 102a-102n may include a switch 234 configured to switch between the high performance applications 202 and the high integrity back-up application 232 when a safety alert is raised by a safety monitor 236. The switch 234 may couple to the safety monitor 236, such that the switch 234 is able to receive the one or more safety alerts from the safety monitor 236.

Each layer of the plurality of layers 102a-102n may include an application selector 238 configured to switch between the one or more high performance applications 202. The application selector 238 may select any of the high performance applications 202a-202n via a decision mechanism (e.g., configuration data file, software logic, or similar) that selects the most preferable application dynamically. The application selector 238 may be configured to generate output data (e.g., application commands, alerts, statuses, and the like). Each layer of the plurality of layers 102a-102n may be configured to perform integrity monitoring of the output data from the application selector. The safety monitor 236 may issue the one or more safety alerts based on an output from the integrity monitoring, alert management, and the like. Each layer of the plurality of layers 102a-102a may further be configured to perform other layer status monitoring/alert consolidation, such that monitoring data is provided by other layers 102 for issues that impact the current layer.

The switch 234 may then generate output data and provide the output data to the output interface 110. The switch 234 may further generate output data (e.g., commands, status, alerts, and the like) and provide the output data to one or more layers. The output interface 110 may further receive integrity assessment data, performance metrics, time horizon of safe operation data, and the like and display the data for the operator to utilize when making decisions.

It is noted herein that by stacking the layers in a hierarchical architecture, the run-time assurance proceeds up the chain in a hierarchical fashion. When a fault occurs somewhere in the system, the system can perform safe behaviors up to the level of the fault. For example, if the vehicle is provided a trajectory that either is too difficult to fly or would otherwise hit an obstacle, it might revert to flying a safe abort route. In doing this, it would abandon the mission, task, and route above, but would otherwise provide the safest behavior it can do for the trajectory layer and down through the rest of the lower layers. By way of another example, if there is a much lower level fault (e.g., an actuator jam), the actuator level would revert to its safe behavior (e.g., declutching, reconfiguring the actuator, or trying to trim the remaining actuators for a wings level condition), but in doing so, the system would abandon all of its upper level expectations (e.g., mission through flight control).

It is noted herein that this hierarchical fault response scheme represents a novel run-time assurance architecture that minimizes system complexity and builds integrity into the system in a systematic manner, and provides operator intuitive fault response behavior (the operator can easily isolate failures within the system based which layer's fault response was triggered). This architecture is additionally beneficial for fault isolation, root cause analysis, integration with one or multiple potentially complex/artificially intelligent applications 202, and also within a certified, safety critical system context by building design assurance and run-time assurance into each layer of the architecture. The design naturally evolves in a modular way enabling developers to add new applications 202 to increase the breadth of capability in a single layer, add new layers 102 to increase the level of automation or granularity of system control, and also to add additional agents 320 to a cooperating team of agents to scale up team level automation capabilities.

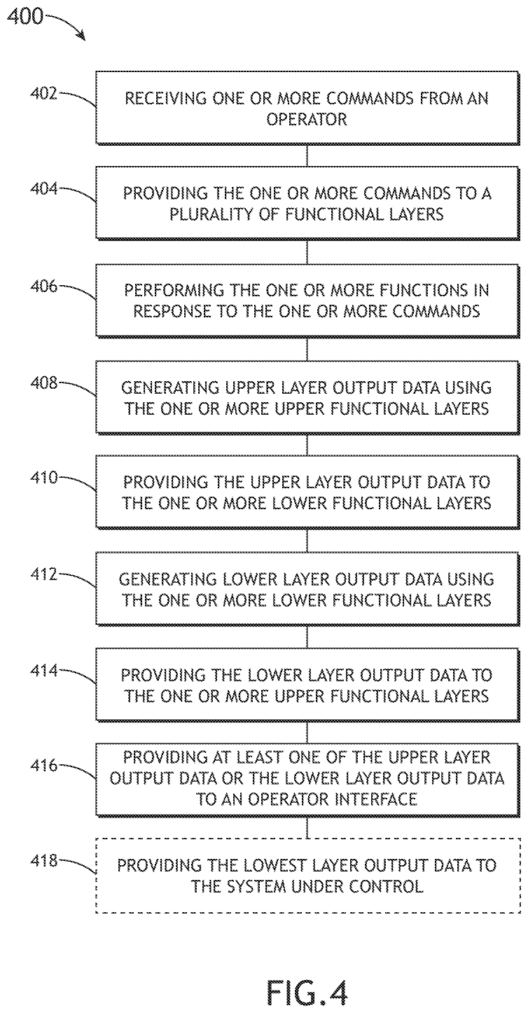

### FIG. 4—Method Overview

FIG. 4 illustrates a flow diagram depicting a method or process 400 for the hierarchical automation system 100, 200, in accordance with one or more embodiments of the disclosure.

In step 402, one or more operator commands may be received in response to an operator selection of a portion of one or more operator interfaces.

In step 404, one or more commands are provided to the plurality of functional layers 102. For example, the plurality of layers 102 may receive one or more operator commands 106 from the operator input interfaces 108.

In step 406, one or more functions may be performed subject to the commands issued by the operator. For example, the layer that received the issued command may be configured to perform one or more functions/objectives based on the issued command.

In step 408, output data may be generated by each upper layer of the system and provided to a lower layer of the system (step 410). For example, each upper layer of the plurality of layers 102a-102n may be configured to generate one or more commands. For instance, the mission coordination layer 102n may generate a command for the task allocation layer 102f which has a lower level of automation than the mission coordination layer 102n.

In step 412, output data may be generated by each lower layer of the system and provided to an upper layer of the system (step 414). For example, each lower layer of the plurality of layers 102a-102n may be configured to generate one or more status outputs. In another instance, the task allocation layer 102f may generate one or more status outputs for the mission coordination layer 102n.

In step 416, the output data generated by the lower and upper layers may be displayed. For example, the one or more output interfaces 110 of the system 100 may display the output data, such that the operator is able to use such data when making decisions (e.g., issuing additional commands, and the like).

In an optional step, output data may be generated by the lowest layer in the system (e.g., the layer with the lowest level of automation) and provided to the system under control 114.

Although embodiments of the disclosure are directed towards a vehicle control (notably aviation) environment, it is noted herein the hierarchical automation system 100, 200 is not limited to this environment. For example, the system 100,200 may be configured to operate in any type of robotic vehicle system known in the art. For instance, the vehicle may be any air, space, land, or water-based personal equipment or vehicle; any air, space, land, or water-based commercial equipment or vehicle; any air, space, land, or water-based military equipment or vehicle known in the art. By way of another example, the system 100,200 may be configured to operate in a robot. By way of another example, the system 100,200 may be configured to operate in a payload system onboard a vehicle. Therefore, the above description should not be interpreted as a limitation on the present disclosure but merely an illustration.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A hierarchical automation system, comprising:
one or more operator input interfaces configured to receive one or more operator commands from an operator; and
a hierarchy of a plurality of functional layers configured to perform one or more functions in response to the received one or more operator commands, the hierarchy of the plurality of functional layers including one or more upper functional layers and one or more lower functional layers, the one or more upper functional layers configured to provide a greater level of automation than the one or more lower functional layers,
each functional layer of the plurality of functional layers comprising:
a plurality of applications;
an arbitrator configured to dynamically select an appropriate input source for the plurality of applications;
an application selector configured to dynamically select an application of the plurality of applications to perform the one or more functions; and
a default safe fallback module configured to selectively provide a substantially safe operation for each functional layer of the plurality of functional layers to perform,
each upper functional layer of the one or more upper functional layers configured to dynamically provide one or more commands to at least one lower functional layer of the one or more lower functional layers, the at least one lower functional layer of the one or more lower functional layers configured to provide a lower level of automation than each upper functional layer of the one or more upper functional layers,
each lower functional layer of the one or more lower functional layers configured to provide one or more status outputs to each upper functional layer of the one or more upper functional layers, the at least one upper functional layer of the one or more upper functional layers configured to provide a greater level of automation than each lower functional layer of the one or more lower functional layers.

2. The system of claim 1, wherein the plurality of applications include one or more high integrity applications configured to provide high integrity behavior, the high integrity behavior configured to provide a substantially safe operation within a set of operating conditions for the one or more high integrity applications, the set of operating conditions being different for each high integrity application of the one or more high integrity applications.

3. The system of claim 2, wherein the application selector is configured to dynamically select at least one high integrity application of the one or more high integrity applications based on at least one of one or more operating conditions, one or more sets of integrity assessment data, one or more sets supporting data, the one or more commands received from the one or more upper functional layers, or the one or more status outputs received from the one or more lower functional layers, the selected high integrity application dynamically selected by the application selector being the high integrity application that is configured to provide the best performance while maintaining integrity and fault tolerance.

4. The system of claim 1, wherein the plurality of applications include one or more high performance applications and a high integrity back-up application.

5. The system of claim 4, wherein each functional layer of the plurality of functional layers further includes:
a safety monitor configured to raise one or more safety alerts based on at least one of one or more operating conditions, one or more sets of integrity assessment data, one or more sets of supporting data, one or more commands received from the one or more upper functional layers, or the one or more status outputs received from the one or more lower functional layers, the safety monitor further configured to clear the one or more safety alerts; and
a switch configured to switch between the one or more high performance applications and the high integrity back-up application when a safety alert of the one or more safety alerts is raised, the switch further configured to switch between the one or more high performance applications and the high integrity back-up application when a safety alert of the one or more safety alerts is cleared.

6. The system of claim 4, wherein each functional layer of the plurality of functional layers further includes:
a safety monitor configured to raise one or more safety alerts based on at least one of one or more operating conditions, one or more sets of integrity assessment data, one or more sets of supporting data, one or more commands received from the one or more upper functional layers, or the one or more status outputs received from the one or more lower functional layers, the safety monitor further configured to clear the one or more safety alerts,
the application selector configured to switch between the one or more high performance applications and the high integrity back-up application when a safety alert of the one or more safety alerts is raised, the application selector further configured to switch between the high integrity back-up application and the one or more high performance applications when a safety alert of the one or more safety alerts is cleared by the safety monitor.

7. The system of claim 1, further comprising:
one or more operator output interfaces configured to display the one or more status outputs.

8. The system of claim 1, wherein each upper functional layer of the one or more upper functional layers is configured to monitor one or more characteristics of the one or more lower functional layers, the one or more lower functional layers configured to provide a lower level of automation than each upper functional layer of the one or more upper functional layers.

9. A multi-agent hierarchy automation system, comprising:
one or more operator input interfaces configured to receive one or more operator commands from an operator;
a hierarchy of a plurality of functional layers configured to perform one or more functions in response to the received one or more operator commands, the hierarchy of the plurality of functional layers including a first set of a plurality of functional layers and at least an additional set of a plurality of functional layers, the first set of the plurality of functional layers including one or more upper functional layers and one or more lower functional layers, the one or more upper functional layers configured to provide a greater level of automation than the one or more lower functional layers, the additional set of the plurality of functional layers including one or more upper functional layers and one or more lower functional layers, the one or more upper functional layers configured to provide a greater level of automation than the one or more lower functional layers,
each functional layer of the plurality of functional layers comprising:
a plurality of applications;
an arbitrator configured to dynamically select an appropriate input source for the plurality of applications;
an application selector configured to dynamically select an application of the plurality of applications to perform the one or more functions; and
a default safe fallback module configured to selectively provide a substantially safe operation for each functional layer of the plurality of functional layers to perform,
each upper functional layer of the one or more upper functional layers of the first set of the plurality of functional layers configured to dynamically provide one or more commands to at least one of a lower functional layer of the one or more lower functional layers of the first set of the plurality of functional layers, a lower functional layer of the one or more lower functional layers of the at least one additional set of the plurality of functional layers, or an equivalent upper functional layer of the at least one additional set of the plurality of functional layers, each lower functional layer of the one or more layer functional layers of the first set and the at least one additional set of the plurality of functional layers configured to provide a lower level of automation than each upper functional layer of the one or more upper functional layers of the first set of the plurality of functional layers, the equivalent upper functional layer of the at least one additional set of the plurality of functional layers configured to provide a substantially similar level of automation as the upper functional layer of the one or more upper functional layers of the first set of the plurality of functional layers,
each lower functional layer of the one or more lower functional layers of the first set of the plurality of functional layers configured to provide one or more status outputs to each upper functional layer of the one or more upper functional layers of the first set of the plurality of functional layers, each upper functional layer of the one or more upper functional layers of the first set of the plurality of functional layers configured to provide a greater level of automation than each lower functional layer of the one or more lower functional layers of the first set of the plurality of functional layers,
each lower functional layer of the one or more lower functional layers of the at least one additional set of the plurality of functional layers configured to provide one or more status outputs to each upper functional layer of the one or more upper functional layers of the at least one additional set of the plurality of functional layers, each upper functional layer of the one or more upper functional layers of the at least one additional set of the plurality of functional layers configured to provide a greater level of automation than each lower functional layer of the one or more lower functional layers of the at least one additional set of the plurality of functional layers,
each lower functional layer of the one or more lower functional layers of the at least one additional set of the plurality of functional layers configured to provide one or more status outputs to at least one of an upper functional layer of the one or more upper functional layers of the first set of the plurality of functional layers or an equivalent lower functional layer of the first set of the plurality of functional layers, the equivalent lower functional layer of the first set of the plurality of functional layers configured to provide a substantially similar level of automation as the lower functional layer of the one or more lower functional layers of the at least one additional set of the plurality of functional layers.

10. The system of claim 9, wherein the plurality of applications include one or more high integrity applications configured to provide high integrity behavior, the high integrity behavior configured to provide a substantially safe operation within a set of operating conditions for the one or more high integrity applications, the set of operating conditions being different for each high integrity application of the one or more high integrity applications.

11. The system of claim 10, wherein the application selector is configured to dynamically select at least one high integrity application of the one or more high integrity applications based on at least one of one or more operating conditions, one or more sets of integrity assessment data, one or more sets supporting data, the one or more commands received from the one or more upper functional layers, or the one or more status outputs, the selected high integrity application dynamically selected by the application selector being the high integrity application that is configured to provide the best performance while maintaining integrity and fault tolerance.

12. The system of claim 9, wherein the plurality of applications include one or more high performance applications and a high integrity back-up application.

13. The system of claim 12, wherein each functional layer of the plurality of functional layers further includes:
a safety monitor configured to raise one or more safety alerts based on at least one of one or more operating conditions, one or more sets of integrity assessment data, one or more sets of supporting data, the one or more received commands, or the one or more received status outputs, the safety monitor further configured to clear the one or more safety alerts; and
a switch configured to switch between the one or more high performance applications and the high integrity back-up application when a safety alert of the one or more safety alerts is raised, the switch further configured to switch between the one or more high performance applications and the high integrity back-up application when a safety alert of the one or more safety alerts is cleared by the safety monitor.

14. The system of claim 12, wherein each functional layer of the plurality of functional layers further includes:
a safety monitor configured to raise one or more safety alerts based on at least one of one or more operating conditions, one or more sets of integrity assessment data, one or more sets of supporting data, one or more received commands, or one or more received status outputs, the safety monitor further configured to clear the one or more safety alerts,
the application selector configured to switch between the one or more high performance applications and the high integrity back-up application when a safety alert of the or more safety alerts is raised, the application selector further configured to switch between the high integrity back-up application and the one or more high performance applications when a safety alert of the one or more safety alerts is cleared by the safety monitor.

15. A method for hierarchical automation, comprising:
receiving one or more commands from an operator;
providing the one or more commands to a plurality of functional layers, the plurality of functional layers including one or more upper functional layers and one or more lower functional layers, the one or more upper functional layers configured to provide a greater level of automation than the one or more lower functional layers;
performing the one or more functions in response to the one or more received commands;
generating upper layer output data using the one or more upper functional layers;
providing the upper layer output data to at least one lower functional layer of the one or more lower functional layers, each lower functional layer of the one or more lower functional layers configured to provide a lower level of automation than each upper functional layer of the one or more upper functional layers;
generating lower layer output data using the one or more lower functional layers;
providing the lower layer output data to each upper functional layer of the one or more upper functional layers, each upper functional layer of the one or more upper functional layers configured to provide a greater level of automation than each lower functional layer of the one or more lower functional layers; and
providing at least one of the upper layer output data or the lower layer output data to one or more operator interfaces.
